(19) United States
(12) Patent Application Publication
(10) Pub. No.: US 2025/0291039 A1
(43) Pub. Date: Sep. 18, 2025

(54) Distance measurement of an object using a time of flight method

(71) Applicant: SICK AG, Waldkirch (DE)

(72) Inventors: Johannes KETTEL, Waldkirch (DE); Eiko HAGER, Waldkirch (DE)

(21) Appl. No.: 19/076,269

(22) Filed: Mar. 11, 2025

(30) Foreign Application Priority Data
Mar. 12, 2024 (DE) 102024107055.2

(51) Int. Cl. G01S 7/487; G01S 7/4863; G01S 7/4865; G01S 17/10

(52) U.S. Cl. CPC G01S 7/4873; G01S 7/4863; G01S 7/4866; G01S 17/10

(57) ABSTRACT

An optoelectronic sensor for the distance measurement of an object in a detection zone using a time of flight method has a light transmitter for transmitting a light signal into the detection zone, a light receiver having a first plurality of Geiger-mode avalanche photodiodes for detecting received light from the detection zone, a second plurality of time of flight measurement units for determining individual times of flight between a transmission of a light signal and a triggering of a detection event in an avalanche photodiode, and a control and evaluation unit configured to collect individual times of flight in a histogram, to localize a useful light signal in the histogram with reference to a threshold, and to determine a distance value from the object from the useful light signal. An extraneous light level is first estimated from the histogram and then the threshold is fixed using the extraneous light level.

The invention relates to an optoelectronic sensor and to a method for the distance measurement of an object in a detection zone using a time of flight method.

A distance measurement or spacing measurement can be used in the most varied areas such as factory automation, logistics automation, or safety engineering. In accordance with one variant of the direct time of flight (dTOF) principle, a brief light pulse is transmitted and the time up to the detection of the remitted or reflected light pulse is measured. Possible applications of a distance measurement are modified light barriers that monitor the distance between their transmitter and their receiver or reflector or switching systems having binary object presence recognition in which the switch state depends on whether there is an object at a specific distance range. The latter sensors are also called background suppression light sensors. A single-beam or one-dimensional distance measurement can be expanded by the use of correspondingly spatially resolving receivers to a linear or planar distance measurement. Laser scanners are likewise based on the time of flight measurement to determine distances at corresponding angle positions.

The detection sensitivity of simple photodiodes as light receivers is not sufficient in a number of application cases. In an avalanche photodiode (APD), the incident light triggers a controlled avalanche effect. The charge carriers generated by incident photons are thus multiplied and a photocurrent is produced that is proportional to the received light intensity, but that is in this respect substantially larger than with a simple PIN diode. In the so-called Geiger mode, the avalanche photodiode is biased above the breakdown voltage such that a single charge carrier released by a single photon can already trigger an avalanche that then recruits all the available charge carriers due to the high field strength. The avalanche photodiode thus, like the eponymous Geiger counter, counts individual events. Geiger-mode avalanche photodiodes are also called SPADs (single photon avalanche diodes).

Geiger-mode APDs or SPADs are therefore very fast, highly sensitive photodiodes based on semiconductors. A disadvantage of the high sensitivity is that not only a useful light photon, but also a weak interference event due to external light, optical crosstalk or dark noise can trigger the avalanche effect. Every single SPAD therefore also measures interference events as apparent run times in addition to the desired times of flight. An interference event then contributes to the measured result with the same relatively strong signal as the received useful light and can also not be distinguished from it using the signal. After an avalanche effect of any cause, the sensitivity of the avalanche photodiode is dramatically reduced for a dead time or recuperation time of approximately 5 to 100 ns so that it is practically missing for further measurements for so long. The pool of SPADs available for the measurement is thus reduced under extraneous light incidence (pile-up effect).

The useful events thus have to be separated from the interference events for a measurement. A large number of individual measurements are conventionally carried out with a plurality of SPADs and/or repeat measurements for this purpose to permit a statistical evaluation, in particular in that the individual measurements are collected in a histogram. A peak that is detectable by a threshold in principle is formed from the useful events there. However, both useful light and interference events are greatly dependent on the respective measurement situation. Slower drifts such as a degradation of the light transmitter and variants in production and in component tolerances also come into play. The fixing of the threshold is therefore extremely demanding and even an ideally adapted static threshold is at best effective under highly controlled measurement conditions.

DE 10 2021 118 660 A1 describes a laser scanner having single photon avalanche diodes and a histogram evaluation by means of Optima filters.

EP 3 428 683 A1 discloses an optoelectronic sensor having a light receiver that has a plurality of SPADs. A selection of these SPADs is associated with a respective one time of flight measurement unit in a 1:1 ratio. A region of interest of the light receiver is thereby selected on which the time of flight measurement is based. The document does not offer any solution for the described threshold problems.

In EP 3 418 767 B1, parameters for the description of the exponentially decreasing frequency of background events is estimated in a further optoelectronic sensor of the category and is further selected using a median filter. The estimate is based on a respective histogram in which measurement events and interference events occur in mixed form; the median filter is intended to conduct the separation. The statistical basis is very limited with only ne histogram, on the one hand. In certain measurement situations, for instance the moving of an object into the detection zone from the side with edge hits, there are additionally very random and multiple peaks which the median filter cannot cope with in the desired manner. In addition, a median filter is comparatively processing intensive because a sorting is necessary that reduces the response time of a sensor on limited and in particular embedded software.

The dissertation by Maik Beer, “SPAD-based sensors for a distance measurement based on the time of flight at high background light intensity”, Duisburg, Essen, University of Duisburg-Essen, 2018, deals with the background light influence on the distance measurement of a sensor of the category.

It is therefore the object of the invention to further improve the time of flight measurement of a distance measuring sensor on a SPAD basis.

This object is satisfied by an optoelectronic sensor, in particular of the sensor types named in the introduction, and by a method for distance measurement of an object in a detection zone using a time of flight method. As customary with a time of flight measurement, a light transmitter transmits a light signal that is received in a light receiver after diffuse remission or direct reflection at an object whose distance is to be measured. The light signal preferably has a brief pulse so that a pulse based method is used (direct time of flight, dTOF). The light receiver comprises a first plurality of avalanche photodiodes or pixels that can be operated in a Geiger mode in which they are biased at a bias greater than the breakdown voltage to trigger an avalanche effect on the reception of light. The term SPAD is also used multiple times for Geiger-mode avalanche photodiodes in the following. A second plurality of time of flight measurement units determine respective individual times of flight between the transmission and reception of a light signal. In this respect, the time of flight measurement units are associated with specific avalanche photodiodes in a ratio of 1:n, 1:1 or n:1 depending on the embodiment, and indeed in different or uniform group sizes. It is possible that a selection is only made of avalanche diodes that are evaluated by a time of flight measurement unit at all to thus fix a region of interest of the light receiver, in particular as described in EP 3 428 683 A1. Individual times of flight are initially not interpreted measured results that can equally correspond to useful events of the light signal returning from an object such as interference events.

A control and evaluation unit evaluates the individual times of flight and initially collects them for this purpose in a histogram over a plurality of time of flight measurement units and/or repeat measurements in which a respective light signal is transmitted and in which it is on hold for a measurement period. The histogram sorts the individual times of flight in a discretization of the measurement period (time bins) and counts the frequency of the respective individual times of flight (count per bin). A useful light signal or peak is then localized in the histogram using a threshold. The distance value is determined from the temporal location of the useful light signal.

The invention starts from the basic idea of first estimating the extraneous light level as information on the current measurement situation to thus be able to dynamically adapt the threshold. The fixed threshold takes account of the model assumptions via a pile-up effect with an exponential drop in the background events over time and maintains a buffer distance defined by a safety margin from the interference events, i.e. the noise events and extraneous light events. The parameterization of the progression of the threshold takes place using the currently measured extraneous light level. It may be advantageous in the specific implementation to use a function such as a polynomial that can be calculated more easily as an approximation of the exponential function.

The invention has the advantage that a reliable measurement is also made possible under the influence of extraneous light. Thanks to a dynamic adaptation of the threshold, objects of low remittance can be recognized at a great distance with little extraneous light whereas with increased extraneous light the threshold is placed such that an incorrect detection is avoided. The threshold used in dependence on the current extraneous light level can already be prepared and defined very carefully at the time of development, where necessary with a great time effort and with a broad data basis. Drifting or degradation processes as well as specimen scattering can thereby also be taken into account over individual sensors of a production series. A selection of the threshold matching the current extraneous light level is only required with a little processing time effort at the time of running.

The time of flight measurement units preferably have a TDC (time-to-digital converter). It is a known and relatively simple component that can determine individual times of flight with a high temporal resolution. TDCs can be directly monolithically integrated in a crystal of the light receiver. The respective TDC is preferably started at the time of transmission and stopped at the reception point in time by the received individual light pulse or, in the event of an interference event, by extraneous light or dark noise. Other operating modes are conceivable, for instance starting the TDCs in each case on the triggering of an avalanche and then stopping them at a known point in time such as at the end of the measurement period.

The control and evaluation unit is preferably configured to estimate the extraneous light level by summing the first bins of the histogram. The first bins are used because no useful light has returned here yet and the pile-up effect has only switched a small number of avalanche photodiodes into their dead time. It must be noted here that the avalanche photodiodes are preferably inactive until a measurement starts to still provide the full pool of recruitable avalanche photodiodes at least initially. A dropping exponential function could already be reconstructed in idealized form from two bins. In actual fact, the measurement is a random experiment so that a higher number of bins should be used. A partial selection of, for example, the second, fifth, and eighth bins should nevertheless also be covered by summing the first bins and the inclusion of all 1 . . . N first bins should only preferably be meant. In any case, the counts in the first bins should be correlated up by the extraneous light level and this relationship is used for its determination. Alternatively, the extraneous light level can be determined by an additional dedicated extraneous light receiver or by at least one avalanche photodiode of the light receiver reserved therefor.

The control and evaluation unit preferably stores a first lookup table that associates an extraneous light level with a summed number of detection events. Store means that the first lookup table (LUT) is stored in the control and evaluation unit or in a memory which it can access. The determination of the extraneous light level at the time of running is then limited to the summing of the first bins and a simple table access to obtain the matching value for the extraneous light level from the sum of the first bins. This is a vary rapid and simple-to-use implementation that manages with very small hardware resources. Intermediate values that are missing from the first lookup table can be interpolated. A fixedly specified function, in particular a polynomial, is preferably used for this purpose, even more preferably that function that has already been used for teaching the first lookup table as immediately explained. However, a simple linear interpolation will frequently be sufficient.

The first lookup table is preferably taught in advance to the distance measurement in that the light receiver is repeatedly exposed to a defined extraneous light level with an inactive light transmitter and the respective sum of the first bins of a histogram generated in this process is determined. The extraneous light is in particular generated by an additional light source. The teaching takes place before the actual measurement operation, for example as early as in the development or in production ex works. In this respect, the light receiver is systematically exposed to varied extraneous light of a known intensity without superposition by useful light by an inactive light transmitter. A histogram is respectively recorded and its first bins are summed. Data pairs are thus produced that associate a sum of the first bins with an extraneous light level. The relationship between the extraneous light level and the sum of the first bins can be derived therefrom in any desired granularity of the first lookup table by averaging or preferably by a function fit or polynomial fit. The fitted function can be stored in the sensor to use it later for interpolation.

The control and evaluation unit is preferably configured to delay the transmission of a light signal with respect to a start signal so that no useful light signal is registered in the first bins of the histogram. The distance measurement range can then start directly in front of the sensor and it is nevertheless ensured that the first bins are free from useful light to be able to estimate the extraneous light level therefrom. The additional delay can be very simply calculated from the measured times of flight. A corresponding calibration is as a rule anyway required for unavoidable internal signal delays that may in another respect replace or complement the artificial delay.

The control and evaluation unit preferably stores a second lookup table that associates at least one matching parameter of a calculation rule for the threshold with an extraneous light level. The threshold is thus predetermined as a calculation rule having at least one parameter not fixed in advance, in particular with a portion of a dropping exponential function and a portion of a safety margin that is preferably likewise based on an exponential function. The at least one parameter is then read out of the second lookup table with reference to the extraneous light level and threshold is thus dynamically adapted to the currently present extraneous light level. With respect to the storage location, the kind of use, the possible interpolation, and the advantages, the same applies to the second lookup table as to the first lookup table.

The second lookup table is preferably taught in advance to the distance measurement in that the light receiver is repeatedly exposed to a defined extraneous light level with an inactive light transmitter and the respective sum HS=Σᵢ₌₁^{M} Histogram (i) and a focus

$$λ = \frac{{\sum }_{i = 1}^{M} Histogram ( i ) * i}{HS}$$

of a histogram generated in this process is determined, where Histogram (i) designates the i=1 . . . M bins of the histogram. The sum HS and the focus λ are then used as the parameters or in the parameters of the threshold. The teaching scenario is comparable to that for the first lookup table; both lookup tables can in particular be taught simultaneously.

The control and evaluation unit is preferably configured to determine the threshold using the calculation rule

$$a exp ( - b i ) + S * \sqrt{a exp ( - b i )} ,$$

using the parameters a and b, and a scaling factor S for the safety margin This is a specific calculation rule that easily models the behavior of the light receiver used The parameters a and b are set corresponding to the extraneous light level present, preferably simply read out of the second lookup table. The first term models the expected progression of the noise threshold. The threshold is displaced upward by the second term as a buffer to intercept scattering over individual measurements. The safety margin S, unlike a and b, is not a parameter dependent on the extraneous light level; the portion below the root already takes this dependence into account. It is rather the case that the ratio of errors of the first and second kinds are weighed via the safety margin S, that is whether it is more tolerated when an object is overlooked as noise or when, conversely, a rare strong noise event is incorrectly detected as an object. The sensor is correspondingly configured ex works or at the operating site by setting S.

$$a = \frac{H S}{λ} and b = \frac{1}{λ}$$

preferably apply to the parameters a and b. In this respect, at least one histogram determined at a defined extraneous light level is preferably derived from the focus. These parameters follow on from a modeling of the behavior of the light receiver that has proved itself very well in practice.

The control and evaluation unit is preferably configured to compare the number of individual times of flight per bin of the histogram with the threshold and to associate bins above the threshold with the useful light signal. The threshold is therefore applied bin by bin to locate those bins in which returning transmitted light has been detected. The useful light signal is thus localized in time. In many measurement situations, there is only one such cluster of bins corresponding to a single useful light peak. The time of flight can then be determined as a maximum, a focus, or a similar measure of these bins or by means of a fit of a peak function to these bins. If there are a plurality of bins that are above the threshold and that are not contiguous as neighbors, a plurality of distance values can be output or, for example, the first, the last, or the most pronounced peak can be used as the basis for the distance value.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

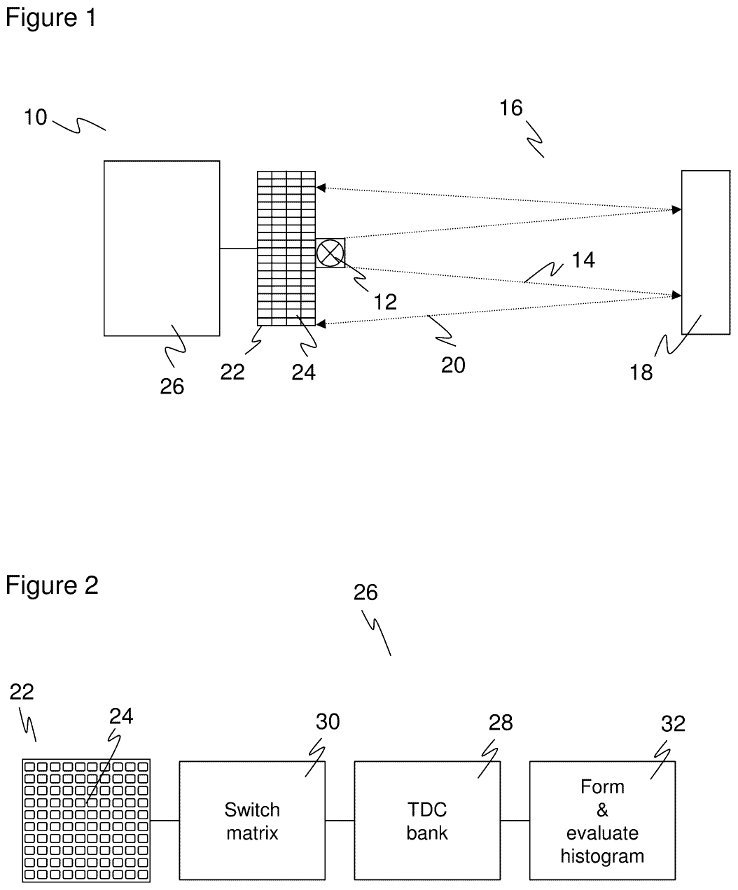

FIG. 1 a schematic representation of an optoelectronic sensor with a time of flight measurement;

FIG. 2 a schematic representation of a light receiver and downstream components for a measurement evaluation;

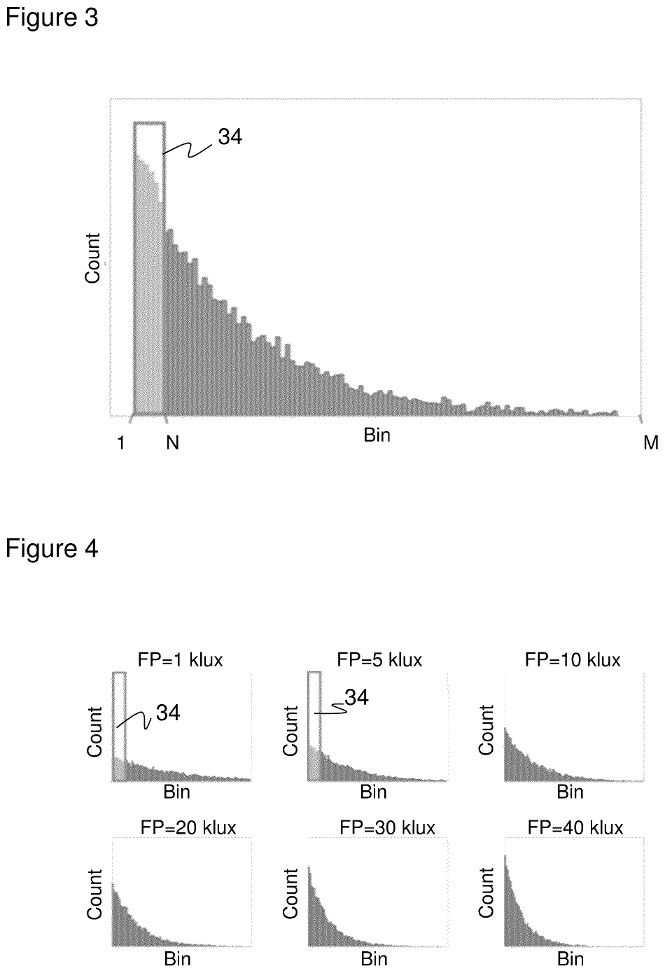

FIG. 3 an exemplary histogram of measured individual times of flight with a pure extraneous light incidence without useful light with an illustration of the summing of the first bins;

FIG. 4 a representation of six exemplary histograms similar to FIG. 3 for different extraneous light levels;

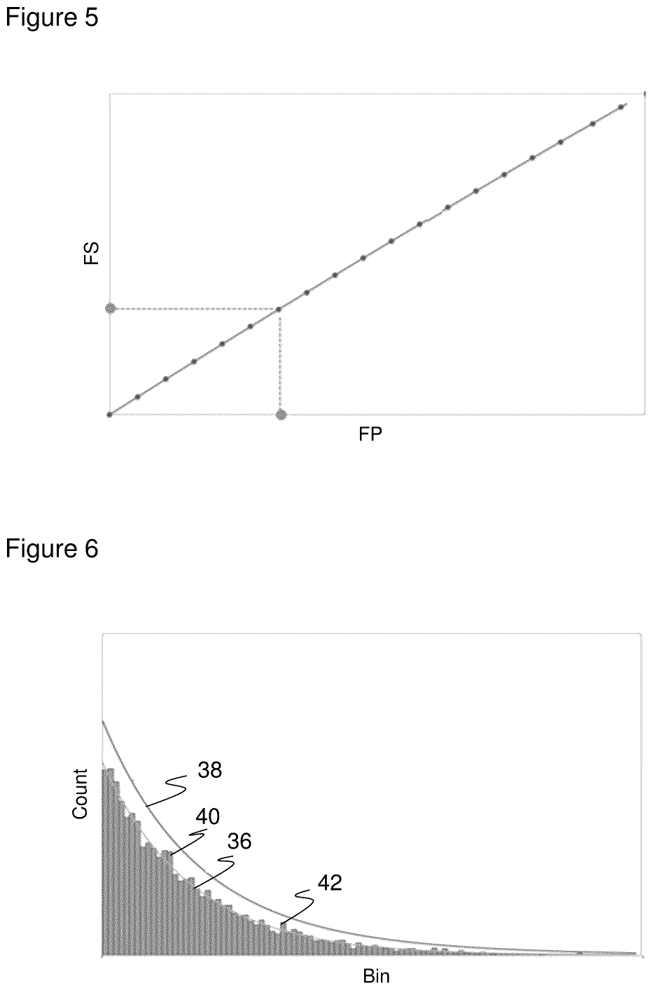

FIG. 5 a representation of the relationship between the summed first bins and the extraneous light level;

FIG. 6 an illustration of a modeling of the extraneous light portion in a histogram and of a threshold thereabove with a safety margin;

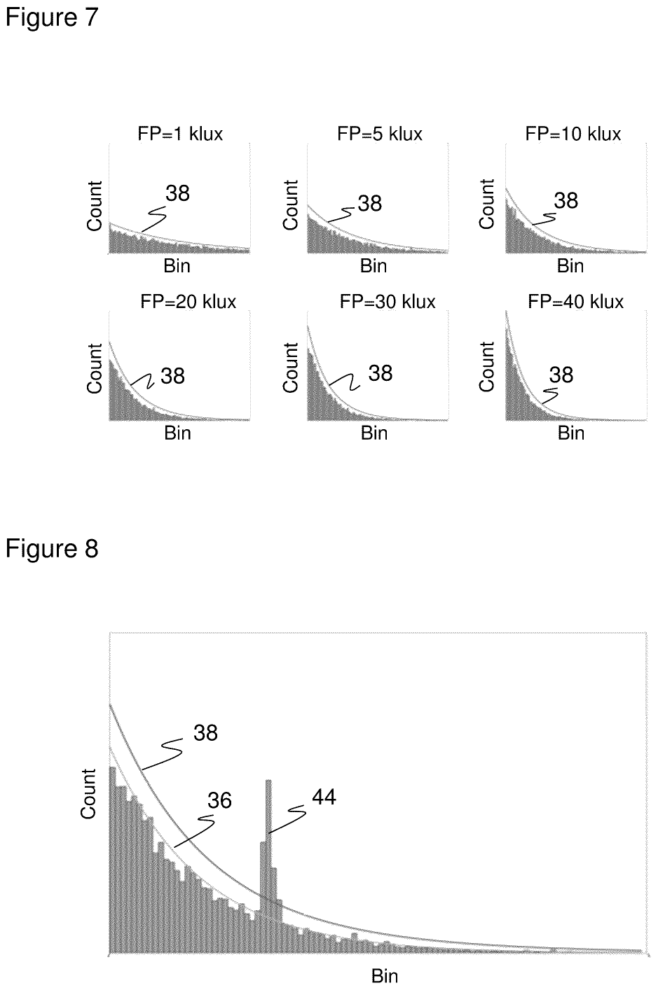

FIG. 7 a representation of six exemplary thresholds similar to FIG. 6 for different extraneous light levels; and

FIG. 8 a representation similar to FIG. 6, but now with a useful light peak that is recognized by the threshold.

FIG. 1 shows a schematic representation of an optoelectronic sensor 10 for distance measurement in accordance with the time of flight principle in a one-dimensional embodiment. The sensor 10 is described as representative for other time of flight measuring sensors, as in particular named in the introduction. A light transmitter 12, for example an LED or a laser light source, transmits a light signal 14 into a monitored zone 16. If there is an object 18 there, a portion of the light is diffusely remitted or reflected and returns as a remitted light signal 20 to the sensor 10 where it is registered in a light receiver 22.

The light receiver 22 comprises a plurality of pixel elements 24, also called SPADs (single photon avalanche diodes) that can be operated in Geiger mode to trigger an avalanche event on reception of light in that they are biased with a bias that is greater than a breakdown voltage. Some basic SPAD properties have already been described in the introduction. The pixel elements 24 are preferably arranged in a matrix. The number of pixel elements 24 can vary; the matrix can, for example, be a square or rectangular arrangement having some tens, hundreds, or even thousands of pixel elements 24 and more.

The light receiver 22 is connected to a sensor control block 26. This is only shown in summary form in FIG. 1; a possible design of the sensor control block 26 will be explained with reference to FIG. 2. The sensor control block 26 controls the light transmitter 12 such that the light signal 14 is transmitted, preferably with a short pulse in the nanosecond or even picosecond range. The time at which a light signal 14 is triggered can be used as a reference for the time of flight measurement. In other embodiments, some of the light signal 14 can serve internally as an optical reference. The sensor control block 26 processes signals of the pixel elements 24 that are evaluated to determine the time of flight from a transmission point in time of the transmitted light signal 14 up to a reception point in time of the remitted light signal 20. The time of flight can be converted into a distance with the aid of the speed of light. The determination of the reception point in time will be explained below with reference to FIGS. 2 to 8.

In practice, the sensor 10 comprises further elements, in particular transmission and reception optics and interfaces that are known per se and have been omitted for reasons of simplicity. A division of the light receiver 22 and of the sensor control block 26 as in FIG. 1 is possible in practical embodiments, but primarily serves for explanation. These components are preferably at least partly integrated on a common chip whose surface is used together by the pixel elements 24 and the circuits that are or can be associated with the pixel elements 24 or groups of pixel elements 24 for their control and evaluation.

A coaxial arrangement is shown in FIG. 1 in which the light transmitter 12 is arranged in front of the light receiver 22. Other coaxial arrangements are possible, for example with the aid of a beam splitter. A biaxial or triangulating arrangement is also conceivable in which the light transmitter 12 and light receiver 22 are arranged next to one another with a mutual offset. The sensor 10 can be a one-dimensional sensor of the kind shown in FIG. 1. Other embodiments, not exclusively named, are light barriers, light grids, and laser scanners. The sensor 10 can output or display a distance value or can also act as a switch in that a switch event is triggered when an object is recognized at a specific distance range, including a deviation from an expected distance range. A plurality of sensors 10 can be combined, for example to form a distance measuring or distance monitoring light grid. Mobile systems are also conceivable in which the sensor 10 is movably supported or scanning systems in which the transmitted light signal 14 sweeps over the monitored zone 16 by means of a moving mirror or by moving the measurement system, in particular by a rotational movement.

FIG. 2 shows a schematic representation of the light receiver 22 and downstream components of the sensor control block 26. The light receiver 22 is in turn shown as a SPAD matrix having a plurality of pixel elements 24. Some of the pixel elements 24 are associated with time of flight measurement units 28 which are time-to-digital converters (TDCs) in this embodiment. A switch device 30 determines the associations, i.e. which pixel elements 24 have been selected for the evaluation and by which time of flight measurement unit 28 they are respectively evaluated. The time of flight information generated by the time of flight measurement units 28 are accumulated and evaluated by a control and evaluation unit 32, preferably after storing the accumulated time of flight information in a memory, not shown separately, and preferably in the form of a histogram. One result of the evaluation is a distance value that may be the basis for further evaluations.

The switch device 30 can be formed as a programmable matrix or in a different manner to associate selected pixel elements 24 with a selected time of flight measurement unit 28 in accordance with a 1:1 or an n:1 scheme. All the pixel elements 24 do not have to be evaluated. One reason for the formation of only selected associations is that a large number of time of flight measurement units 28, that corresponds to the number of pixel elements 24, cannot be implemented or at least is too expensive and requires too much chip surface. The number of time of flight measurement units 28 therefore preferably only amounts to a fraction of the number of pixel elements 24. In addition, the signal-to-noise ratio can be improved by the preferred selection of pixel elements 24 in a region of interest (ROI) that actually receives the remitted light signal 20.

The time of flight measurement units 28 measure a respective individual time of flight between the transmission of the transmitted light signal 14 and the reception of the remitted light signal 20. In an embodiment, the time of flight measurement units 28 are started on the transmission of the light signal 14 and are stopped by an avalanche event in the connected pixel element(s) 24. In another embodiment, they are started by the avalanche event and stopped at a reference point in time, with the offset between the transmission point in time and the reference point in time being compensated by calculation. Every individual time of flight is per se very unreliable since the measured avalanche event can be caused by environmental light or dark noise instead of by the remitted light signal 20 so that the corresponding individual time of flight is possibly completely uncorrelated with the distance to be measured.

The individual times of flight of the time of flight measurement units 28 are therefore accumulated in a histogram, preferably for improved statistics, also over repeat measurements, and are evaluated by the control and evaluation unit 32. The histogram divides a measurement period into temporal bins in which the respective number of individual times of flight is counted that fall into the time interval of a bin. On reception of the remitted light signal 20, a peak forms in this histogram whose temporal position determines the reception point in time.

As already mentioned, the light receiver 22 and the components of the sensor control block 26 can be integrated on the same chip. In a preferred embodiment, the light receiver 22, the time of flight measurement units 28, and the switch device 30 are part of an ASIC (application specific integrated circuit) while the control and evaluation unit 32 is implemented on a microprocessor. In a further embodiment, the control and evaluation unit 32 is likewise at least partly integrated in the ASIC. The memory for the histograms can be part of the ASIC, of the microprocessor, or can be a separate component. This is only a preferred hardware implementation; the functionality of the sensor control block 26 can alternatively be implemented on one or more arbitrary hardware components such as an ASIC, a CPU (central processing unit), an FPGA (field programmable gate array), a DSP (digital signal processor), or the like.

FIG. 3 shows an exemplary histogram of measured individual times of flight with a pure extraneous light incidence without useful light of the remitted light signal 20. The respective number of individual times of flight (count) is shown on the Y axis as the height of the bars of the respective bins on the X axis. Without useful light, the histogram only contains a noise portion or background events (pile-up) in an exponential drop that results from the dead times of the pixel elements 24 after an avalanche event. A total of M bins is provided corresponding to a measurement period or a maximally detectable distance. A reception of useful light is only possible from the bin N+1 onward due to unavoidable and/or intentional delays from the internal trigger for the transmission of the light signal 14 and the actual transmission point in time. The first N bins can therefore be used at the run time for a pure extraneous light estimate, with other noise events being added to the extraneous light portion in a simplified manner in the following. The summed first N bins highlighted in the box 34, i.e. FS=Σᵢ₌₁^{M} Histogram (i) with the count Histogram (i) in the ith bin are highly correlated with the extraneous light level.

FIG. 4 shows a representation of six exemplary histograms similar to FIG. 3 for different extraneous light levels. Data pairs (FSₙ, FPₙ) for different extraneous light levels such as FP₀=0 Klux, FP₁=1 KLux, . . . can be acquired in a desired number in that the sensor 10 or the light receiver 22 is exposed to such known and defined extraneous light levels before the measurement operation, for example during development production, or putting into operation.

FIG. 5 shows a representation of the relationship between FP and FS, that is the extraneous light level and the summed first N bins. The data pairs (FSₙ, FPₙ) can be used to fit a function, for example a straight line or a polynomial such as FS_{Fit}(x)=p₀+p₁x+p₂x². A first lookup table LUT1 can be generated therefrom in any desired granularity for a particularly efficient implementation. Alternatively, only the coefficients p₀, p₁, p₂ are stored. Measured summed first N bins FS are transformed via the first lookup table LUT1 into estimated extraneous light levels FP during measurement operation. Intermediate values can be rounded or interpolated.

Alternatively to a dynamic estimate of the extraneous light level, a fixed configuration is conceivable that sets a specific extraneous light strength ex works or on the customer side and specifies an FP as a parameter for this purpose. The use of an additional reception element or of at least one pixel element 24 in which only extraneous light is measured by channel separation from the useful light is furthermore conceivable as an alternative to the estimate of the extraneous light level over summed first N bins FS.

FIG. 6 shows an illustration of a modeling of the exponential progression 36 of the extraneous light portion in a histogram and of a threshold 38 thereabove with a safety margin. The fixing of the threshold is the actual goal; the estimate of the extraneous light level FP is an intermediate step on the way to this.

The exponential progression 36 can be estimated over a few parameters for every extraneous light level FP. The density function of the exponential distribution has the general form:

$$f ( i ) = \frac{1}{λ} exp ( - \frac{1}{λ} i ) .$$

The model parameter λ can be estimated by means of a maximum likelihood method for every measured extraneous light histogram including all the measured values. The maximum likelihood method makes possible a robust parameter estimate while utilizing all the present measured data in a histogram.

A reliable estimated value for λ results for the exponential distribution as a mean value or as a focus of all the measured individual times of flight of a histogram as

$$λ = \frac{{Σ}_{i = 1}^{M} Histogramm ( i ) * i}{H S} .$$

HS=Σᵢ₌₁^{M} Histogram(i) is the sum of the numbers of all the bins of the histogram.

The exponential progression 36 of the extraneous light portion is the expected value E(i) for the number of background events in every histogram bin i and is calculated as

$$E ( i ) = HS * f ( i ) = \frac{HS}{λ} exp ( - \frac{1}{λ} i ) .$$

This is not yet the threshold 38 since at least some bins 40, 42 with counts randomly elevated with respect to the expected value E(i) are also above it. A safety margin should therefore be taken into account between them.

Assuming a Poisson distribution of the extraneous light events over the bins, the standard deviation can be directly calculated since the expected value and the variance are identical here:

$$Std ( i ) = \sqrt{E ( i )} = \sqrt{\frac{HS}{λ} exp ( - \frac{1}{λ} i )} .$$

The associated threshold 38 that is called the noise threshold RG(i) of the respective ith bin can now be fixed by scaling the standard deviation with a desired factor S, for example, in the range S=2 . . . 6 for the safety margin:

$$RG ( i ) = E ( i ) + S * Std ( i ) .$$

If now the parameter λₙ and HSₙ is determined from an extraneous light histogram as described above via the maximum likelihood for a specific extraneous light level FPₙ, then

$${RG}_{n} ( i ) = \frac{{HS}_{n}}{{λ}_{n}} exp ( - \frac{1}{{λ}_{n}} i ) + preFact * \sqrt{\frac{{HS}_{n}}{{λ}_{n}} exp ( - \frac{1}{{λ}_{n}} i )} .$$

applies to the threshold 38.

If the parameter (aₙ, bₙ) is now defined as

$$( {b}_{n} = \frac{1}{{λ}_{n}} , {a}_{n} = \frac{{HS}_{n}}{{λ}_{n}} ) ,$$

the threshold 38 is simplified to

$${RG}_{n} ( i ) = {a}_{n} exp ( - {b}_{n} i ) + S * \sqrt{{a}_{n} exp ( - {b}_{n} i )} ,$$

and a second lookup table LUT2 can be formed that associates the parameters (aₙ, bₙ) with a respective extraneous light level FPₙ, In measurement operation, only the parameters (aₙ, bₙ) with the current extraneous light level FPₙ have to be looked up to be able to calculate the threshold 38 using the above equation for RGₙ(i) per bin i. The extraneous light level FPₙ is in turn, as described, acquired from the first lookup table LUT1 or is otherwise measured. An approximation, for example in the form of a polynomial, can be used to reduce the effort for the calculation of an exponential function and roots.

FIG. 7 shows a representation of six exemplary thresholds 38 similar to FIG. 6 for different extraneous light levels FP that have been determined in accordance with the procedure just explained.

FIG. 8 shows a representation similar to FIG. 6 to explain the further evaluation using the matching threshold 38. Unlike the previously shown histograms, a useful light peak 44 was also registered here that is safely delineated from the background via the threshold 38. The counts of each bin i are, for example, compared with the associated threshold RGn(i). The bins with a count above the threshold contain the information on the temporal location of the sought useful light peak 44. If there is more than one bin above the threshold, the maximum, a focus or a comparable measure can be formed, for example, in particular weighted by the exponential drop, from the bins above the threshold to determine the reception point in time. Alternatively, a progression of the transmission pulse can be fitted, indeed also in a simplified form, for example a parabola. If there are a plurality of non-contiguous bins above the threshold, the first, the most pronounced, or the last cluster, or a cluster otherwise specified in accordance with a rule is selected or a plurality of reception points in time are calculated for a plurality of clusters. Such a multi-goal measurement results, for example, with an object behind another (semi-) transparent object.

In a particularly preferred embodiment, the two lookup tables LUT1 and LUT2 are determined at the time of development as described and at times with an absolutely large time and measurement effort and are stored in the respective sensor 10. It is then sufficient in operation to calculate the sum FS of the first N of a histogram and to read an extraneous light level FPₙ from the first lookup table LUT1. For this purpose, the corresponding noise threshold RGₙ is in turn read from the second lookup table LUT2 or a specified calculation rule for the threshold 38 is adapted from a few parameters of the second lookup table LUT2, such as (aₙ, bₙ). The useful light peak 44 is then reliably recognized in front of the background by this threshold in the current extraneous light situation.

1. An optoelectronic sensor for the distance measurement of an object in a detection zone using a time of flight method, wherein the sensor has a light transmitter for transmitting a light signal into the detection zone, a light receiver having a first plurality of Geiger-mode avalanche photodiodes for detecting received light from the detection zone, a second plurality of time of flight measurement units for determining individual times of flight between a transmission of a light signal and a triggering of a detection event in an avalanche photodiode, and a control and evaluation unit that is configured to collect individual times of flight in a histogram, to localize a useful light signal in the histogram with reference to a threshold, and to determine a distance value from the object from the useful light signal,
wherein the control and evaluation unit is furthermore configured to first estimate an extraneous light level from the histogram and then to fix the threshold using the extraneous light level such that it is above an expected exponentially decreasing number of noise and extraneous light events with a safety margin.

2. The sensor in accordance with claim 1,
wherein the control and evaluation unit is configured to estimate the extraneous light level by summing the first bins of the histogram.

3. The sensor in accordance with claim 2,
wherein the control and evaluation unit stores a first lookup table that associates an extraneous light level with a summed number of detection events.

4. The sensor in accordance with claim 3,
wherein the first lookup table is taught in advance to the distance measurement in that the light receiver is repeatedly exposed to a defined extraneous light level with an inactive light transmitter and the respective sum of the first bins of a histogram generated in this process is determined.

5. The sensor in accordance with claim 1,
wherein the control and evaluation unit is configured to delay the transmission of a light signal with respect to a start signal so that no useful light signal is registered in the first bins of the histogram.

6. The sensor in accordance with claim 1,
wherein the control and evaluation unit stores a second lookup table that associates at least one matching parameter of a calculation rule for the threshold with an extraneous light level.

7. The sensor in accordance with claim 6,
wherein the second lookup table is taught in advance to the distance measurement in that the light receiver is repeatedly exposed to a defined extraneous light level with an inactive light transmitter and the respective sum HS=Σᵢ₌₁^{M}, Histogram (i) and a focus
$$λ = \frac{{\sum }_{i = 1}^{M} Histogramm ( i ) * i}{HS}$$
of the histogram generated in this process is determined, where Histogram (i) designates the i=1 . . . M bins of the histogram.

8. The sensor in accordance with claim 1,
wherein the control and evaluation unit is configured to determine the threshold using the calculation rule
$$a exp ( - b i ) + S * \sqrt{a exp ( - b i )} ,$$
using the parameters a and b, and a scaling factor S for the safety margin.

9. The sensor in accordance with claim 8,
wherein
$$a = \frac{HS}{λ} and b = \frac{1}{λ}$$
apply to the parameters a and b, where λ is derived from the focus of at least one histogram determined with a defined extraneous light level.

10. The sensor in accordance with claim 1,
wherein the control and evaluation unit is configured to compare the number of individual times of flight per bin of the histogram with the threshold and to associate bins above the threshold with the useful light signal.

11. A method for the distance measurement of an object in a detection zone using a time of flight method, wherein a light signal is transmitted into the detection zone, a light receiver having a first plurality of Geiger-mode avalanche photodiodes detects received light from the detection zone, a second plurality of time of flight measurement units determines individual times of flight between a transmission of a light signal and a triggering of a detection event in an avalanche photodiode, individual times of flight are collected in a histogram, a useful light signal is localized in the histogram with reference to a threshold, and a distance value from the object is determined from the useful light signal,
wherein an extraneous light level is first estimated from the histogram and then the threshold is fixed using the extraneous light level such that it is above an expected exponentially decreasing number of noise and extraneous light events with a safety margin.
